(19) United States
(12) Patent Application Publication
(10) Pub. No.: US 2026/0306324 A1
(43) Pub. Date: Oct. 8, 2026

(54) PATIENT SUPPORT APPARATUS OPERATION AND USE

(71) Applicant: Hill-Rom Services, Inc., Batesville, IN (US)

(72) Inventors: Gregory John Shannon, Indianapolis, IN (US); Mahesha Madapattana Basavaraju, Fuquay Varina, NC (US); Eric David Benz, Sunman, IN (US); Reid Domingo, Batesville, IN (US); Rakesh Karunakaran, Batesville, IN (US); Unnati Ojha, Apex, NC (US); Edward Pizzella, Batesville, IN (US); Bryan Matthew Weidman, Columbus, IN (US)

(21) Appl. No.: 19/629,479

(22) Filed: Mar. 26, 2026

Related U.S. Application Data
(60) Provisional application No. 63/783,723, filed on Apr. 4, 2025.

(51) Int. Cl. A61G 7/018; A61G 7/015; A61G 7/057

(52) U.S. Cl. CPC A61G 7/018; A61G 7/015; A61G 7/05769; A61G 2203/20; A61G 2203/32; A61G 2203/36; A61G 2203/44

(57) ABSTRACT

A patient support apparatus includes a frame and a deck having articulable sections for supporting a patient support surface. Position sensors detect a positioning of the articulable sections of the deck. Pressure sensors detect pressures inside bladders of the patient support surface. An actuator adjusts a state of at least one of the deck and the patient support surface. A monitoring device measures physiological variables of a patient when resting on the patient support surface. A controller determines an optimal state of at least one of the deck and the patient support surface by using artificial intelligence to analyze measurements of the physiological variables, the positioning of the articulable sections of the deck, and the pressures inside bladders of the patient support surface. The controller generates a controllable function that causes the at least one of the deck and the patient support surface to have the optimal state.

### CROSS-REFERENCE TO RELATED APPLICATIONS

This patent application claims the benefit of U.S. Provisional Patent Application No. 63/783,723, filed Apr. 4, 2025, the disclosure of which is hereby incorporated by reference in its entirety.

### BACKGROUND

Hospital beds are sophisticated medical devices equipped with numerous features and therapy options designed to enhance patient care and outcomes. These beds incorporate various systems including pressure redistribution, position adjustment, and therapeutic modes such as percussion and vibration (P&V) or continuous lateral rotation therapy (CLRT). The complexity of these features presents significant challenges for busy healthcare providers who often have to make decisions about bed settings and therapeutic interventions while managing multiple patients. Also, healthcare providers have limited access to real-time patient condition information when manually activating and adjusting the features and therapy options on current hospital bed systems. Additionally, the transfer of information such as bed settings and therapy options between shift changes can be challenging, potentially affecting the continuity of care.

Existing hospital bed systems primarily consider basic factors such as patient weight and position, failing to account for other factors that could influence optimal bed configuration and settings. Also, traditional bed control systems typically operate through independent subsystems, which lack integration to provide comprehensive care recommendations based on multiple patient inputs. Furthermore, current technology relies heavily on predetermined algorithms that may not adequately address the complex, dynamic nature of patient care needs or adapt to individual patient responses to various therapeutic interventions.

### SUMMARY

In general terms, the present disclosure relates to a hospital bed system that utilizes artificial intelligence to optimize patient care by automated monitoring and recommendations. In one possible configuration, the system continuously monitors multiple patient inputs including physiological variables such as heart rate and respiratory rate, patient motion, weight, and position, and bed inputs such as bed position and patient support surface firmness to generate recommendations for optimal bed settings and modes of operation. Various aspects are described in this disclosure, which include, but are not limited to, the following aspects.

One aspect relates to a patient support apparatus, comprising: a frame; a deck supported on the frame, the deck having articulable sections that are configured to support a patient support surface; position sensors configured to detect a positioning of the articulable sections of the deck; pressure sensors configured to detect pressures inside bladders of the patient support surface; at least one actuator mounted on the frame, the at least one actuator configured to adjust a state of at least one of the deck and the patient support surface; a monitoring device having one or more sensors that measure at least one physiological variable of a patient when resting on the patient support surface without contacting the patient; and a controller communicatively coupled to the position sensors, the pressure sensors, the at least one actuator, and the monitoring device, the controller having at least one processing device, and at least one memory device storing software instructions that, when executed by the at least one processing device, cause the at least one processing device to: receive measurements of the at least one physiological variable of the patient; determine an optimal state of at least one of the deck and the patient support surface, the optimal state determined by artificial intelligence analyzing the measurements of the at least one physiological variable, the positioning of the articulable sections of the deck, and the pressures inside bladders of the patient support surface; and generate a controllable function that causes the at least one of the deck and the patient support surface to have the optimal state.

Another aspect relates to a method of operating a patient support apparatus, the method comprising: receiving measurements of at least one physiological variable of a patient resting on a patient support surface without contacting the patient; determining an optimal state of at least one of the patient support surface and articulable sections of a deck that supports the patient support surface, the optimal state determined by artificial intelligence analyzing the measurements of the at least one physiological variable, a positioning of the articulable sections of the deck, and pressures inside bladders of the patient support surface; and generating a controllable function that causes the at least one of the deck and the patient support surface to have the optimal state.

Another aspect relates to a controller for a patient support apparatus, the controller comprising: at least one processing device; and at least one memory device storing software instructions that, when executed by the at least one processing device, cause the at least one processing device to: receive measurements of at least one physiological variable of a patient resting on a patient support surface without contacting the patient; determine an optimal state of at least one of the patient support surface and articulable sections of a deck that supports the patient support surface, the optimal state determined by artificial intelligence analyzing the measurements of the at least one physiological variable, a positioning of the articulable sections of the deck, and pressures inside bladders of the patient support surface; and generate a controllable function that causes the at least one of the deck and the patient support surface to have the optimal state.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### DESCRIPTION OF THE FIGURES

The following drawing figures, which form a part of this application, are illustrative of the described technology and are not meant to limit the scope of the disclosure in any manner.

FIG. 1 is a front isometric view of an example of a patient support apparatus.

FIG. 2 is a rear isometric view of the patient support apparatus of FIG. 1.

FIG. 3 is a front isometric view of another example of the patient support apparatus of FIG. 1 with a patient support surface shown in phantom.

FIG. 4 is a cross-sectional view of an example of a patient support surface in a flat orientation when supported by a deck of the patient support apparatus of FIG. 1.

FIG. 5 is a cross-sectional view of an example of the patient support surface in a partially inclined orientation supported by the deck of the patient support apparatus of FIG. 1.

FIG. 6 is a cross-sectional view of an example of the patient support surface in a fully inclined orientation when supported by the deck of the patient support apparatus of FIG. 1.

FIG. 7 schematically illustrates an example of the patient support apparatus of FIG. 1.

FIG. 8 schematically illustrates an example of a method of operating the patient support apparatus of FIG. 1.

FIG. 9 schematically illustrates an example of input parameters that are received in an operation of the method of FIG. 8.

FIG. 10 illustrates an example of a graphical user interface displayed on a display of the patient support apparatus of FIG. 1 that displays input parameters captured by a monitoring device installed on the patient support apparatus of FIG. 1.

FIG. 11 illustrates another example of a graphical user interface displayed on the display of the patient support apparatus of FIG. 1 that includes an optimize button generated by an AI optimization tool.

FIG. 12 illustrates an example of a graphical user interface displayed on a display of a device communicatively coupled to a nurse call system, the graphical user interface including an optimize button generated by the AI optimization tool.

### DETAILED DESCRIPTION

The disclosed invention provides a practical application that improves patient care through technological integration of sensors, artificial intelligence, and automated responses in a hospital bed system. This practical implementation addresses specific technological problems in healthcare while providing concrete benefits and improvements to existing patient care systems through AI-driven optimization and recommendations.

A patient support apparatus implements a concrete technological solution by utilizing multiple integrated sensors to capture real-time patient data, including a monitoring device having one or more sensors that measure physiological variables such as heart rate and respiration rate, load cells that detect patient position, motion, and weight distribution, position sensors that monitor bed articulation angles, and pressure sensors that detect pressures inside one or more bladders of a patient support surface. This comprehensive sensor fusion provides an integrated monitoring system that enables detection of patient conditions and behaviors.

The patient support apparatus provides a tangible improvement to healthcare technology through artificial intelligence that processes the sensor data to generate optimized recommendations for bed settings and therapeutic modes of operation. The patient support apparatus provides a technological implementation by displaying actionable information regarding recommendations about adjusting particular settings and/or initiating particular modes of operation based on detected patient conditions and behaviors.

The practical application extends to specific automated responses and adjustments. When the hospital bed system detects certain patient conditions or behaviors, the AI algorithms automatically determine optimal bed settings, such as repositioning articulated sections of the bed or modifying patient support surface pressure, while following defined protocols and safety parameters. These automated responses represent concrete physical actions that directly improve patient care and comfort through dynamic pressure redistribution and position optimization.

The invention further demonstrates its practical application through integration with existing healthcare systems. For example, the technology described herein interfaces with electronic health records (EHR) systems, admission/discharge/transfer (ADT) systems, and nurse call systems, creating a comprehensive care platform that enhances healthcare delivery through specific technological improvements. This integration enables the hospital bed system to make informed decisions based on patient medical history and current care protocols.

The hospital bed system includes specific display implementations that provide visual feedback through mounted displays on the patient support apparatus. The displays show concrete recommendations based on patient conditions and behaviors, providing users with actionable information that improves patient care efficiency. The visual interface components include an "optimize" button that enables one-press implementation of AI-generated recommendations.

The practical application is further demonstrated through the hospital bed system's ability to generate specific alerts and recommendations based on detected patient conditions. These alerts are communicated through defined channels to caregivers' devices, representing a concrete implementation of the technology that improves response times and patient care outcomes. The system's ability to learn from patient outcomes demonstrates a practical application that continuously improves its effectiveness through specific technological means.

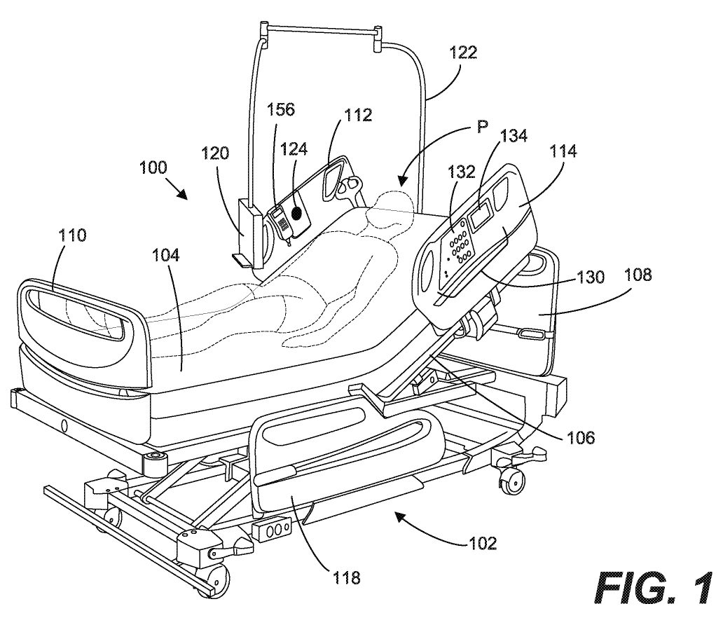

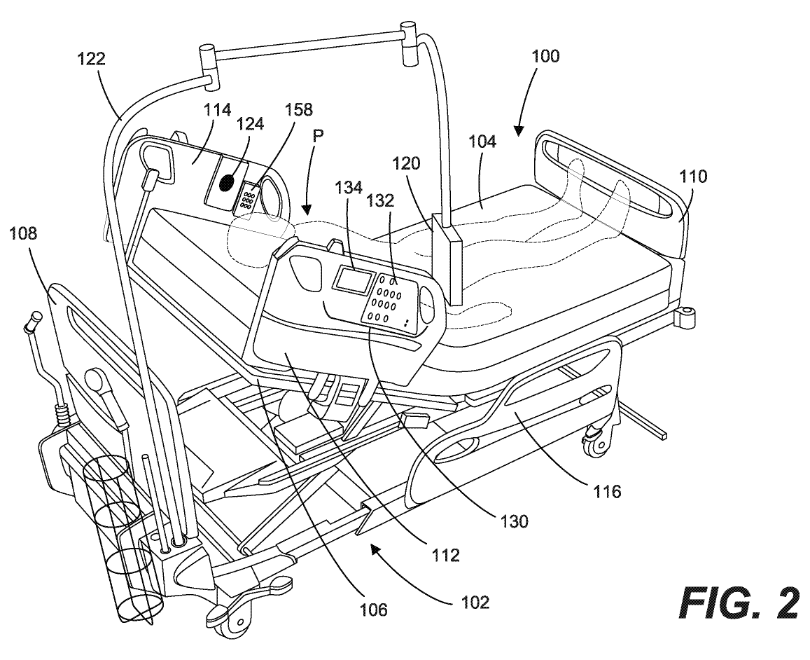

FIG. 1 is a front isometric view of an example of a patient support apparatus 100. FIG. 2 is a rear isometric view of the patient support apparatus 100. The patient support apparatus 100 is shown monitoring a patient P who is resting on a patient support surface 104 supported by a frame 102 of the patient support apparatus 100. In some examples, the patient support surface 104 is a mattress. As will be described in more detail further below, artificial intelligence is used to determine optimal settings and/or therapies on the patient support apparatus 100 to enhance the effectiveness of the patient support apparatus 100.

Artificial intelligence is used to detect conditions and behaviors of the patient P while resting on the patient support apparatus 100, and the artificial intelligence is further used to recommend adjustment of one or more settings of the patient support apparatus 100 to improve the healthcare of the patient. The patient support apparatus 100 can automatically adjust the one or more settings based on the recommendation. Alternatively, the patient support apparatus 100 adjusts the one or more settings following approval of the recommendation by authorized users of the patient support apparatus 100 such as qualified caregivers (e.g., nurses).

In the example shown in FIGS. 1 and 2, the patient support apparatus 100 is depicted as a hospital bed. In alternative examples, the patient support apparatus 100 can include a stretcher, a surgical table, or other structures configured to support a patient within a healthcare environment such as a hospital, nursing home, long term care facility, and the like.

The patient support apparatus 100 includes the frame 102, a deck 106 coupled to the frame 102, and the patient support surface 104 positioned on the deck 106. A headboard 108 is coupled to the frame 102 and a footboard 110 coupled to the deck 106.

The patient support apparatus 100 further includes a plurality of siderails such as a pair of upper siderails coupled to the deck 106 and a pair of lower siderails coupled to the frame 102. The pair of upper siderails include a left upper siderail 112 and a right upper siderail 114. The pair of lower siderails include a left lower sideral 116 and a right lower siderail 118.

The left and right upper siderails 112, 114 each include a control panel 130 that includes controls 132 for adjusting one or more settings of the patient support apparatus 100 such as to adjust the height of the patient support surface 104, the relative angles between one or more articulable sections of the deck 106, the firmness of the patient support surface 104, to raise the siderails to prevent the patient P from exiting from the patient support apparatus 100, or to lower the siderails to allow the patient P to exit the patient support apparatus 100. The controls 132 can further be used to activate therapies on the patient support apparatus 100 such as percussion and vibration (P&V) or continuous lateral rotation therapy (CLRT), which are described below.

The control panel 130 further includes a display 134 that displays information. The display 134 can include a touchscreen that receives inputs from authorized users of the patient support apparatus 100 such as physicians, registered nurses (RN), and other healthcare professionals. The display 134 can use various technologies to sense the inputs from the authorized users such as capacitance to detect changes in an electrical field when a conductive object (e.g., finger or stylus) touches the display 134 to select an object displayed thereon.

The upper siderails can further include microphone and speaker units 124. In some examples, only one of the left upper siderail 112 or the right upper siderail 114 includes a microphone and speaker unit 124. In other examples, both the left upper siderail 112 and the right upper siderail 114 include a microphone and speaker unit 124.

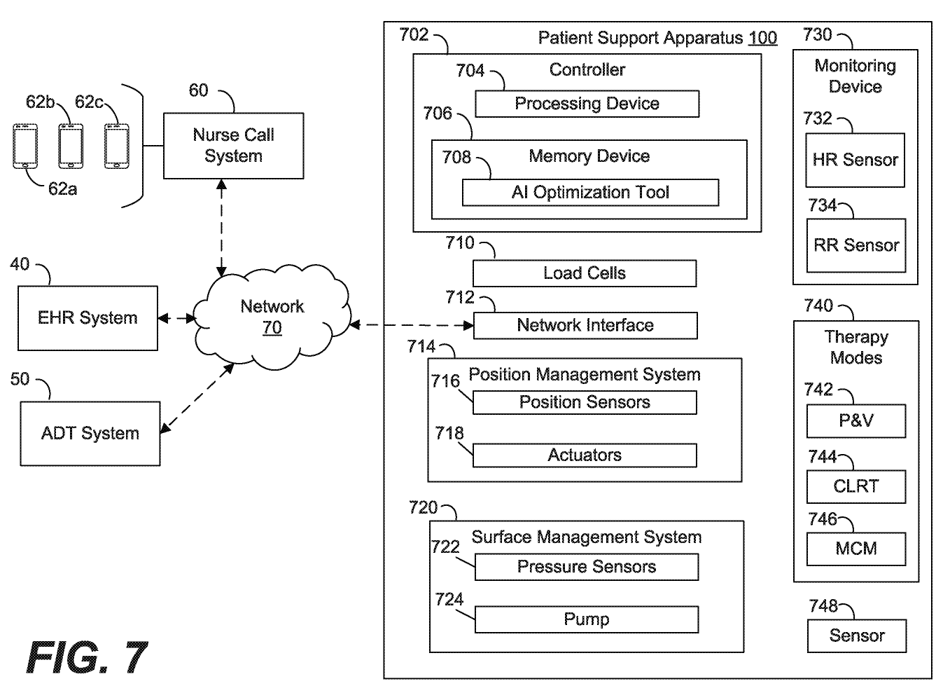

The microphone and speaker unit 124 can be used to provide voice communications between the patient P and caregivers who are not physically present near the patient support apparatus 100 via a nurse call system 60, shown in FIG. 7. In some examples, the microphone and speaker unit 124 provides one-way voice communications (from the caregivers to the patient P or from the patient P to the caregivers). Alternatively, the microphone and speaker unit 124 can provide two-way voice communications between the patient P and the caregivers.

As an illustrative example, the patient P can push a button or switch on a nurse call interface 156 positioned adjacent to the microphone and speaker unit 124 on an upper siderail of the patient support apparatus 100 that causes the microphone and speaker unit 124 to record a voice message for relay to one or more devices 62 by the nurse call system 60. The microphone and speaker unit 124 can also provide playback of voice messages by the caregivers captured by the one or more devices 62. In some examples, the microphone and speaker unit 124 allows a live two-way conversation to occur between the patient P and the remotely located caregivers.

As further shown in the example of FIGS. 1 and 2, the patient support apparatus 100 includes a patient interface device 120 that can be physically attached to the patient support apparatus 100 by an overhead arm assembly 122. The overhead arm assembly 122 allows the patient interface device 120 to be suspended in front of the patient P. The patient P can grab the patient interface device 120 to swivel the patient interface device 120 left and right and/or to pull the patient interface device 120 up and down such that the patient interface device 120 can be comfortably held by the patient P while resting on the patient support apparatus.

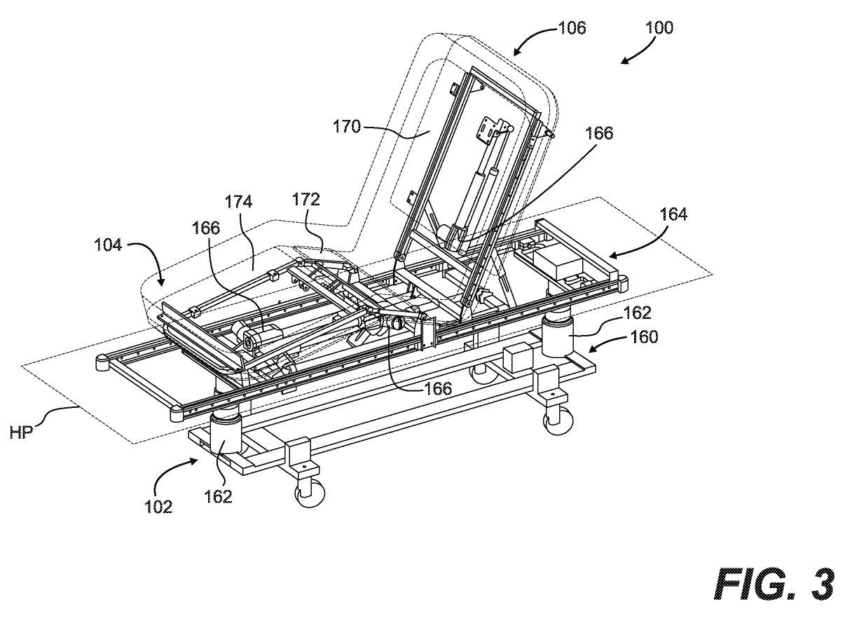

FIG. 3 is a front isometric view of another example of the patient support apparatus 100 with the patient support surface 104 shown in phantom. As shown in FIG. 3, the frame 102 includes a lower frame 160, a first set of actuators 162 coupled to the lower frame 160, and an upper frame 164 movably supported above the lower frame 160. The first set of actuators 162 are controllable to raise and lower the upper frame 164 with respect to the lower frame 160, and thereby adjust a height of the patient support surface 104 relative to the floor. The first set of actuators 162 are also controllable to move the upper frame 164 between various orientations such as a flat orientation parallel to a horizontal plane HP, a Trendelenburg orientation, and a reverse Trendelenburg orientation.

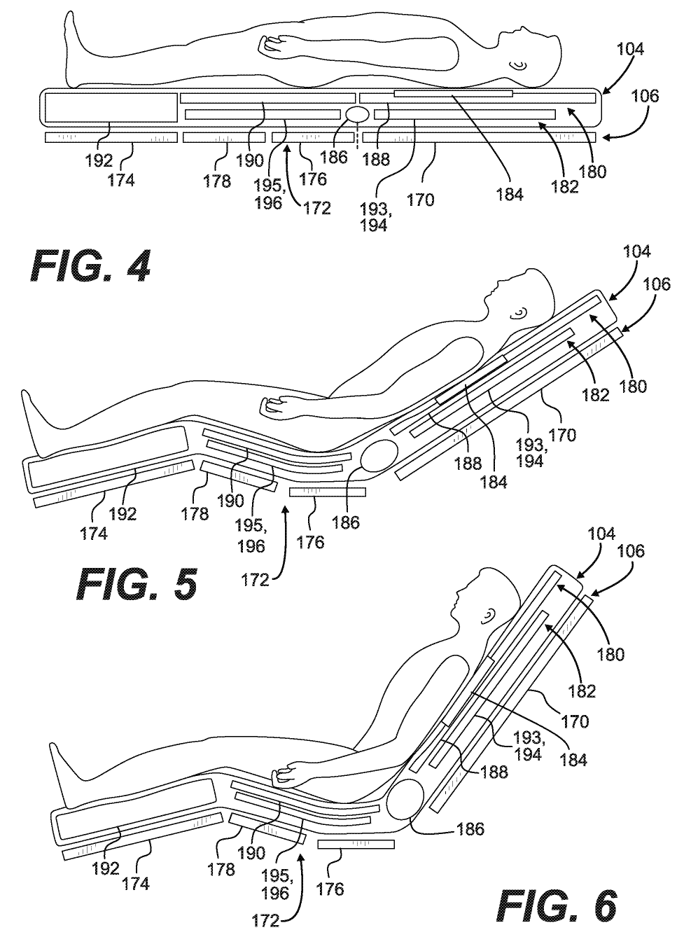

The frame 102 includes a second set of actuators 166 that are controllable to adjust relative angles between articulable sections of the deck 106. For example, the deck 106 includes a head section 170, a seat section 172, and a foot section 174 that are hinged or pivotally coupled to the deck 106 such that relative angles between the head section 170, the seat section 172, and the foot sections 174 are adjustable by the second set of actuators 166 to adjust the contour and/or orientation of the patient support surface 104, as shown in FIGS. 4-6. The first and second sets of actuators 162, 166 can include any type of electric motors, or combinations thereof.

FIG. 4 is a cross-sectional view of an example of the patient support surface 104 supported by the deck 106 shown in the flat orientation. FIG. 5 is a cross-sectional view of an example of the patient support surface 104 supported by the deck 106 shown in a partially inclined orientation. FIG. 6 is a cross-sectional view of an example of the patient support surface 104 supported by the deck 106 shown in a fully inclined orientation. In the example shown in FIGS. 4-6, the seat section 172 of the deck 106 includes a bottom portion 176 and a thigh portion 178 that are separate from one another.

Referring now to FIGS. 3-6, the patient support surface 104 is coupled to the deck 106 and moves with the deck 106 as the deck is repositioned. The patient support surface 104 includes a foam shell, a plurality of inflatable bladders supported by the foam shell, and a cover encasing the foam shell and the bladders. The foam shell underlies the inflatable bladders and supports the bladders. The inflatable bladders are coupled to a valve box included in the patient support surface 104 and are configured to be inflated and deflated to support and apply therapies to the patient P while resting on the patient support surface 104. The cover encapsulates the foam shell and the bladders and accommodates movement of the foam shell and the inflatable bladders during repositioning of the deck 106.

The inflatable bladders included in the patient support surface 104 can include support bladders 180, rotation bladders 182, percussion and vibration bladders 184, and a fill bladder 186. The support bladders 180 are configured to be inflated to support the patient P when lying on the patient support surface 104. The rotation bladders 182 are positioned below the support bladders 180 and are configured to inflate to rotate the patient P when lying on the patient support surface 104 about a longitudinal axis of the patient support surface 104. The percussion and vibration bladders 184 are positioned above the support bladders 180 and are configured to apply a percussion and vibration (P&V) therapy to the patient P when lying on the patient support surface 104. The fill bladder 186 is configured to fill a gap between the support bladders 180 when the deck 106 of the patient support apparatus 100 is repositioned.

The support bladders 180 include head-support bladders 188, seat-support bladders 190, and foot-support bladders 192. The head-support bladders 188 include a plurality of laterally extending inflatable cells that are positioned over the head section 170 of the deck 106. The foot-support bladders 192 include a plurality of laterally extending inflatable cells that are positioned adjacent to the foot section 174 of the deck 106. The seat-support bladders 190 include a plurality of laterally extending inflatable cells positioned between the head-support bladders 188 and the foot-support bladders 192 adjacent to the seat section 172 of the deck 106.

The rotation bladders 182 include left and right head-turn bladders 193, 194 and seat-turn bladders 195, 196. The left and right head-turn bladders 193, 194 are arranged to lie under the patient P's torso when the patient P is lying on the patient support surface 104 to turn the patient P's torso along the longitudinal axis of the patient support surface 104 depending on which head-turn bladder 193, 194 is inflated. The left and right seat-turn bladders 195, 196 are arranged to lie under the patient P's seat and thighs when the patient P is lying on the patient support surface 104 to turn the patient P's legs along the longitudinal axis depending on which seat-turn bladder 195, 196 is inflated.

FIG. 7 schematically illustrates an example of the patient support apparatus 100. In the example embodiment shown in FIG. 7, the patient support apparatus 100 is communicatively coupled to various systems that store data related to the health condition and/or status of the patient P. Based on the health condition or status, the patient support apparatus 100 determines optimal settings and/or therapies for activation on the patient support apparatus 100 that improve patient outcomes such as to accelerate patient discharge from a healthcare facility. In the example illustrated in FIG. 7, the patient support apparatus 100 is communicatively coupled via a network 70 to an electronic health record (EHR) system 40, and an admission, discharge, and transfer (ADT) system 50, and the nurse call system 60. In alternative examples, the patient support apparatus 100 can be communicatively coupled to additional types of systems.

The EHR system 40 maintains the medical history of the patient P by consolidating health information, including patient demographics, medical diagnoses, treatment plans, medications, test results, physiological variable measurements, and immunization history, into a single electronic document called an electronic health record (EHR). The EHR system 40 manages a plurality of EHRs for a plurality of patients. The EHR system 40 enables sharing of data among healthcare professionals to improve coordination of care, reduce errors, and enhance patient outcomes. The EHR system 40 also supports clinical decision-making by providing real-time access to comprehensive patient health information. The EHR system 40 can include features such as secure data storage and integration with other healthcare technologies, which streamline administrative tasks and improve overall healthcare efficiency and patient safety.

The ADT system 50 tracks and manages the patient P’s journey from admission to the healthcare facility through discharge or transfer to another facility. When the patient P is first admitted, the ADT system 50 records details such as personal information, medical history, and the reason(s) for admission, while also assigning a unique identifier to the patient P. When the patient P is discharged or transferred, the ADT system 50 updates the status of the patient P, and facilitates the transfer of relevant medical records to other departments or facilities. By automating these processes, the ADT system 50 improves the efficiency of operations in the healthcare facility, reduces errors, ensures regulatory compliance, and enhances patient care by providing up-to-date information to healthcare providers.

The nurse call system 60 facilitates efficient interaction between the patient P resting on the patient support apparatus 100 and caregivers dispersed throughout the healthcare facility. The nurse call system 60 utilizes bedside call buttons on or adjacent to the patient support apparatus 100 such as on an upper siderail next to the microphone and speaker unit 124 or on the patient interface device 120 that allow the patient P to alert the caregivers for assistance. Once activated, the nurse call system 60 sends a signal to the nurse’s station or to devices 62 carried by the caregivers while on shift in the healthcare facility to notify the caregivers of the patient's request and their location. The nurse call system 60 ensures prompt responses to medical needs of the patient P to improve workflow efficiency and promote patient safety.

As shown in FIG. 7, the patient support apparatus 100 includes a controller 702. In some examples, the controller 702 is associated with the frame 102. For example, the controller 702 can be mounted on the frame 102. In other examples, the controller 702 is communicatively coupled to the frame 102 such as through one or more wired or wireless connections.

The controller 702 includes at least one processing device 704 and at least one memory device 706 that stores software instructions that, when executed by the at least one processing device 704, cause the at least one processing device 704 to perform the aspects, functions, and operations described herein. The at least one processing device 704 is an example of a processing unit such as a central processing unit (CPU). The at least one processing device 704 can include one or more CPUs. The at least one processing device 704 can include digital signal processors, field-programmable gate arrays, and/or other types of electronic circuits.

The at least one memory device 706 is an example of a computer-readable data storage device that operates to store data and instructions for execution by the at least one processing device 704. The at least one memory device 706 includes computer-readable media, which includes any media that can be accessed by the at least one processing device 704. The computer-readable media can include computer-readable storage media and computer-readable communication media. The computer-readable storage media includes volatile and nonvolatile, removable and non-removable media implemented in any device that can store information such as computer-readable instructions, data structures, program modules, or other data. The computer-readable storage media can include random access memory, read only memory, electrically erasable programmable read only memory, flash memory, and other memory technology, including any medium that can be used to store information that can be accessed by the at least one processing device 704. The computer-readable storage media is non-transitory.

The computer-readable communication media embodies computer-readable instructions, data structures, program modules, or other data in a modulated data signal such as a carrier wave or other transport mechanism and includes any information delivery media. The term modulated data signal refers to a signal that has one or more of its characteristics set or changed in such a manner as to encode information in the signal. The computer-readable communication media can include wired media such as a wired network or direct-wired connection, and wireless media such as acoustic, radio frequency, infrared, and other wireless media. Combinations of any of the above are within the scope of computer-readable media.

As shown in FIG. 7, the at least one memory device 706 stores an artificial intelligence (AI) optimization tool 708 that continuously monitors multiple input parameters including physiological variables such as heart rate and respiratory rate, patient motion, weight, and position to generate recommendations for optimal settings and therapies for execution on the patient support apparatus 100. Such optimal settings can improve the healthcare provided to the patient P, which can lead to improved patient outcomes. Examples of improved patient outcomes include accelerated patient discharge times, lower infection and injury rates, fewer nurse calls, reduced exits from the patient support apparatus 100, reduced patient falls, increased patient satisfaction, and the like.

The AI optimization tool 708 can include aspects of artificial intelligence, neural networks, machine learning, and the like. The training of the AI optimization tool 708 can leverage existing tools from MathWorks and Python. The AI optimization tool 708 can be initially trained using proprietary data belonging to a manufacturer of the patient support apparatus 100. While the AI optimization tool 708 is designed to run directly on the patient support apparatus 100, the AI optimization tool 708 can also be executed on external servers.

The training architecture incorporates multiple layers of data integration and processing. The AI optimization tool 708 learns from various sensor inputs including measurements of one or more physiological variables such as heart rate and respiration rate, load cell data that tracks patient position, weight distribution, and motion, pressure sensor readings from the bladders of the patient support surface 104, and positional data of the articulable sections of the deck 106. This sensor fusion approach enables comprehensive monitoring of patient health condition.

The training methodology implements sophisticated behavioral pattern recognition by processing historical data from both individual patients and larger patient populations. This includes analyzing the outcomes of previous recommendations and correlating patient health conditions and outcomes with specific settings and/or therapies executed on the patient support apparatus 100. Inputs for training the AI optimization tool 708 can include outputs of other AI models whether they are discrete classification or regression AI models or other types of models. The AI optimization tool 708 can employ closed-loop learning, continuously improving its performance based on success rates of its recommendations and the resulting patient outcomes. The neural network architecture is designed with consideration given to various training techniques specifically chosen for medical applications. The training process is deliberately controlled and targeted, recognizing the stringent requirements of medical device applications.

Contextual awareness is built into the training process through integration of multiple healthcare data sources. The AI optimization tool 708 learns to incorporate patient medical history from electronic health records, admission and discharge data, and nurse call system interactions. This comprehensive data integration enables the AI optimization tool 708 to make informed and contextually appropriate recommendations for optimal bed settings and therapies.

The patient support apparatus 100 can access patient health information from the EHR system 40 and assess signs of health deterioration by correlating other information gathered from either sensors on the patient support apparatus 100 or adjacent devices. For example, the patient support apparatus 100 can detect signs of pneumonia for the patient P when the respiratory rate of the patient P becomes abnormally high or irregular. The patient support apparatus 100 can use the detection of the signs of pneumonia to recommend optimal settings and therapies for execution on the patient support apparatus 100.

The patient support apparatus 100 includes one or more load cells 710 communicatively coupled to the controller 702. The load cells 710 capture data for analysis by the controller 702 to detect a position, a center of gravity or a weight distribution of the patient P while resting on the patient support surface 104, when the patient P changes position or moves on the patient support surface 104, and when the patient P exits the patient support apparatus 100, or attempts to do so.

The patient support apparatus 100 includes a network interface 712 that allows the patient support apparatus 100 to connect to the network 70. The network interface 712 can include wired interfaces and/or wireless interfaces. For example, the network interface 712 can wirelessly connect to the network 70 such as through Wi-Fi and other wireless communications protocols. Alternatively, or additionally, the network interface 712 can connect to the network 70 using wired connections such as through Ethernet or Universal Serial Bus (USB) cables.

The network 70 can include any type of wired or wireless connections or any combinations thereof. Examples of wireless connections include Wi-Fi, Bluetooth, ultra-wideband (UWB), radio frequency identification (RFID), cellular network connections, and the like. In some examples, the network 70 is an Internet-of-things (IoT) network that connects and exchanges data between one or more devices and the patient support apparatus 100 over the Internet or other communications networks. In alternative examples, one or more of the devices can directly communicate with the patient support apparatus 100 without using the network 70 such as via direct wireless or wired connections with the patient support apparatus 100.

The patient support apparatus 100 includes a position management system 714 communicatively coupled to the controller 702. The position management system 714 includes one or more position sensors 716 that detect a position of the frame 102 and its components including positioning of the upper frame 164 relative to the lower frame 160, and relative positioning of the head section 170, the seat section 172, and the foot section 174 of the deck 106. The position management system 714 communicates the position data to the controller 702 which uses the position data to determine a state of the patient support apparatus 100 such as whether the frame 102 is in a lowered position, a raised position, a Trendelenburg position, a reverse Trendelenburg position, a chair position, or other position or orientation. The position data can be used to train the AI optimization tool 708 such as by associating the position data to patient outcomes such as discharge times, health deterioration, and the like.

The position management system 714 further includes one or more actuators 718 such as the first set of actuators 162 for adjusting the positioning of the upper frame 164 relative to the lower frame 160, and the second set of actuators 166 for adjusting the relative positioning of the head section 170, the seat section 172, and the foot section 174 of the deck 106. The controller 702 communicates instructions to the position management system 714 that causes the one or more actuators 718 to position the frame 102 and the articulable sections of the deck 106 into any of the aforementioned positions based on commands received from the control panel 130 or the patient interface device 120. As will be described in more detail, the AI optimization tool 708 can generate an “optimize” button for display on the display 134 that when selected causes the one or more actuators 718 to position the frame 102 and the articulable sections of the deck 106 into an optimal orientation based on the detected condition or behavior of the patient P.

The patient support apparatus 100 further includes a surface management system 720 communicatively coupled to the controller 702. The surface management system 720 includes pressure sensors 722 that measure the pressure inside the various bladders of the patient support surface 104. Pressure changes inside the bladders of the patient support surface 104 detected by the pressure sensors 722 can be used to detect motion of the patient P on the patient support apparatus 100, in addition to, or separately from, the data captured by the load cells 710. Further, the pressure data can be used to train the AI optimization tool 708 such as by associating the pressure data to patient outcomes such as discharge times, health deterioration, and the like.

The surface management system 720 further includes a pump 724 which can be controlled by the controller 702 to inflate one or more bladders inside the patient support surface 104 to regulate the firmness of one or more portions of the patient support surface 104 such as a firmness of a portion of the patient support surface 104 above the head section 170 of the deck 106, a firmness of another portion of the patient support surface 104 above the seat section 172 of the deck 106, and/or a firmness of another section of the patient support surface 104 above the foot section 174 of the deck 106. In such examples, the patient support surface 104 is a powered air mattress that operates under different modes of operation.

The patient support surface 104 can operate under a normal mode that provides continuous full-body pressure redistribution for the patient P where the pump 724 automatically adjusts the pressure inside the bladders of the patient support surface 104 to accommodate changes in patient weight distribution. The patient support surface 104 can also operate under a maximum inflate mode where the pump 724 inflates the bladders to maximize the firmness of the patient support surface 104. The patient support surface 104 can also operate under a turn mode where the pump 724 inflates one side of the patient support surface 104 and deflates an opposite side of the patient support surface 104 to facilitate turning the patient P on the patient support surface 104.

The patient support apparatus 100 further includes a monitoring device 730 that is communicatively coupled to the controller 702. The monitoring device 730 includes one or more sensors that measure at least one physiological variable of the patient P when resting on the patient support surface 104 without contacting the patient. For example, the monitoring device 730 can be positioned below the patient support surface 104 on the deck 106 such that the monitoring device 730 does not contact the patient P when the patient P rests on the patient support surface 104. The monitoring device 730 can share aspects with the sensor described in U.S. Patent No. 11,896,406 B2, issued Feb. 13, 2024, entitled Patient Support Apparatus Having Vital Signs Monitoring and Alerting, the disclosure of which is herein incorporated by reference in its entirety.

In FIG. 7, the monitoring device 730 is shown as having a first sensor 732 for measuring heart rate and a second sensor 734 for measuring respiration rate. Alternatively, the first and second sensors 732, 734 can be combined into a single sensor that measures both heart rate and respiration rate. The monitoring device 730 can include additional sensors for measuring additional physiological variables of the patient P without contacting the patient.

In some examples, the first sensor 732 also detects heart arrhythmias such as tachycardia which is a rapid heartbeat (e.g., over 100 beats per minute), bradycardia which is a slow heartbeat (e.g., below 60 beats per minute), atrial fibrillation which is a quivering or fluttering of the atria (i.e., upper chambers of the heart), ventricular fibrillation where the ventricles (lower chambers of the heart) quiver irregularly, palpitations, and other heart related conditions. In some examples, the second sensor 734 also detects respiratory conditions such as wheezing, coughing, mucus secretion, asthma, and other conditions that affect breathing.

The patient support apparatus 100 can execute one or more therapy modes 740. The patient support apparatus 100 can operate under a percussion and vibration (P&V) mode 742 which causes rapid inflation and deflation of the percussion and vibration bladders 184 such that waves of pressure pulsate to mobilize secretions in the lungs. The frequency of percussion can be varied from one to five pulses or beats per second. Vibration therapy occurs when the air pulse frequency is increased beyond five pulses per second. P&V therapies can be done separately or together as a sequential treatment. Also, the P&V therapies can be adjusted for duration, percent of maximum pressure applied, and frequency of the beats delivered. These adjustments may allow patients to begin at a lower level, and titrate to tolerance and/or efficacy. As will be described further below, selection of the “optimize” button generated by the AI optimization tool on the display 134 can cause the patient support apparatus 100 to perform the P&V mode 742.

The patient support apparatus 100 can also operate under a continuous lateral rotation therapy (CLRT) mode 744 which causes the rotation bladders 182 to inflate and deflate to position the patient P from side to side on a continuous or intermittent basis. The CLRT mode 744 is performed to prevent or treat respiratory complications. As will be described further below, selection of the “optimize” button generated by the AI optimization tool on the display 134 can cause the patient support apparatus 100 to perform the CLRT mode 744.

The patient support apparatus 100 can also operate under a microclimate management (MCM) mode 746 to decrease localized heat and moisture buildup that occurs between the patient P and the patient support surface 104. As will be described further below, selection of the “optimize” button generated by the AI optimization tool on the display 134 can cause the patient support apparatus 100 to perform the MCM mode 746 in instances when it has been turned off.

Additional modes of operation executed on the patient support apparatus 100 can include a sleep mode where certain features that generate noise (e.g., fan/blower) and/or generate light (e.g., the display 134) are turned off to provide a quiet and dark environment while the patient P is sleeping on the patient support apparatus 100. In some examples, the AI optimization tool 708 determines when the patient P is sleeping based on data collected from one or more sensors on the patient support apparatus 100 such as the load cells 710, the position sensors 716, the pressure sensors 722, and/or the one or more sensors of the monitoring device 730.

In some examples, the patient support apparatus 100 includes a sensor 748 to detect the presence of a caregiver such as by detecting a wireless signal emitted by a tag attached to an object worn or otherwise carried by the caregiver. The wireless signals can include radio frequency (RF) signals, optical (e.g., infrared) signals, or acoustic (e.g., ultrasound) signals. The sensor 748 on the patient support apparatus 100 can include a transmitter, a receiver, or both. In some examples, the sensor 748 allows the patient support apparatus 100 to be a reference point in a real-time locating system (RTLS) implemented in the healthcare facility.

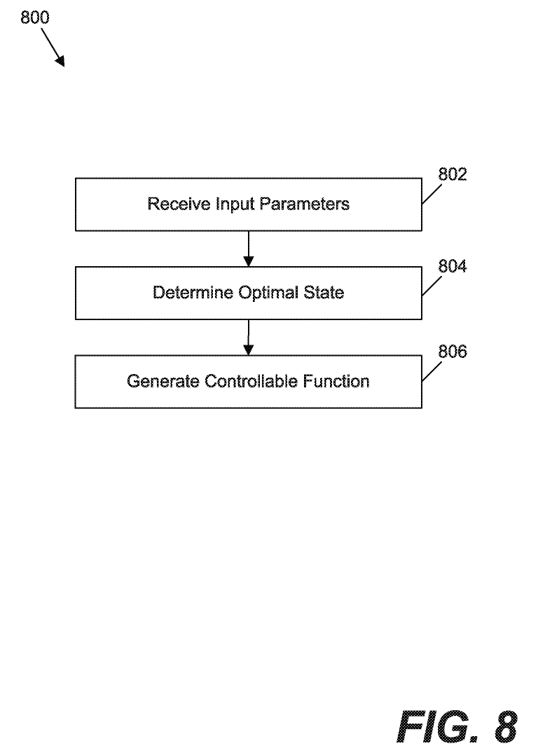

FIG. 8 schematically illustrates an example of a method 800 of operating the patient support apparatus 100. The method 800 can be performed by the AI optimization tool 708 to enhance the effectiveness of the patient support apparatus 100 in providing healthcare.

The method 800 includes an operation 802 of receiving input parameters from the various sensors on the patient support apparatus 100. Operation 802 can include receiving measurements of at least one physiological variable of the patient P resting on the patient support surface 104 without contacting the patient P. In some examples, operation 802 can also include receiving input parameters from external systems such as the EHR system 40, the ADT system 50, and the nurse call system 60. Additional sources of the input parameters are possible.

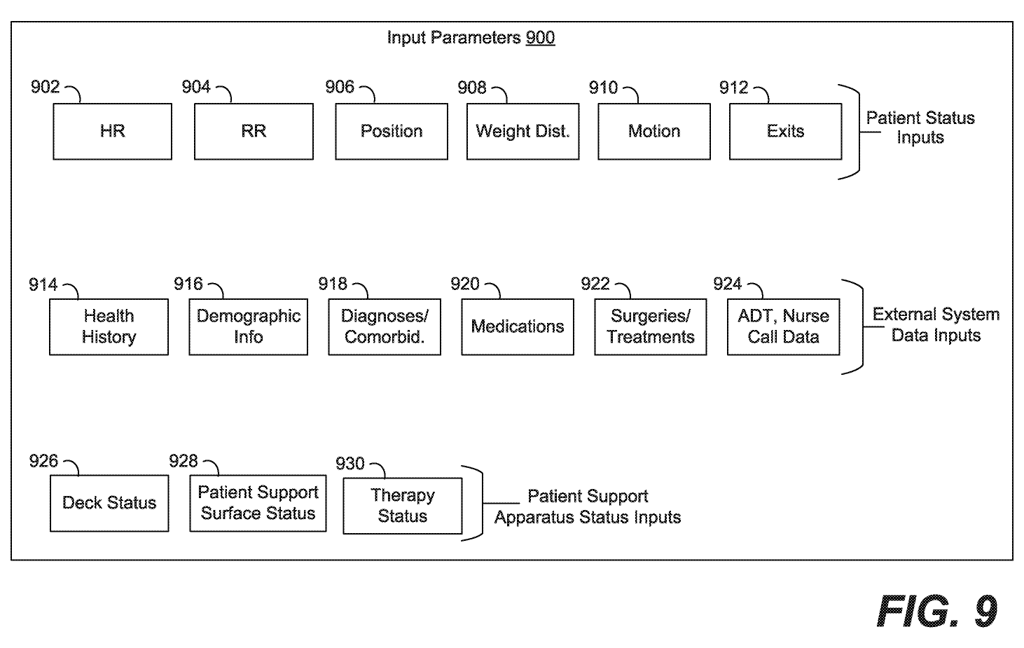

FIG. 9 schematically illustrates an example of input parameters 900 that can be received in operation 802 of the method 800. As will be described in more detail further below, the AI optimization tool 708 analyzes the input parameters 900 to generate a recommendation for optimal settings and/or therapy modes for execution on the patient support apparatus 100. Additionally, the input parameters 900 can be used to train the AI optimization tool 708.

The input parameters 900 include patient status inputs such as one or more physiological variable measurements acquired from the monitoring device 730 such as heart rate measurements 902 and respiration rate measurements 904. The patient status inputs can further include conditions detected by the monitoring device 730 such as heart arrhythmias including tachycardia, bradycardia, atrial fibrillation, ventricular fibrillation, palpitations, and the like, and respiratory conditions such as wheezing, coughing, mucus secretion, asthma, and the like.

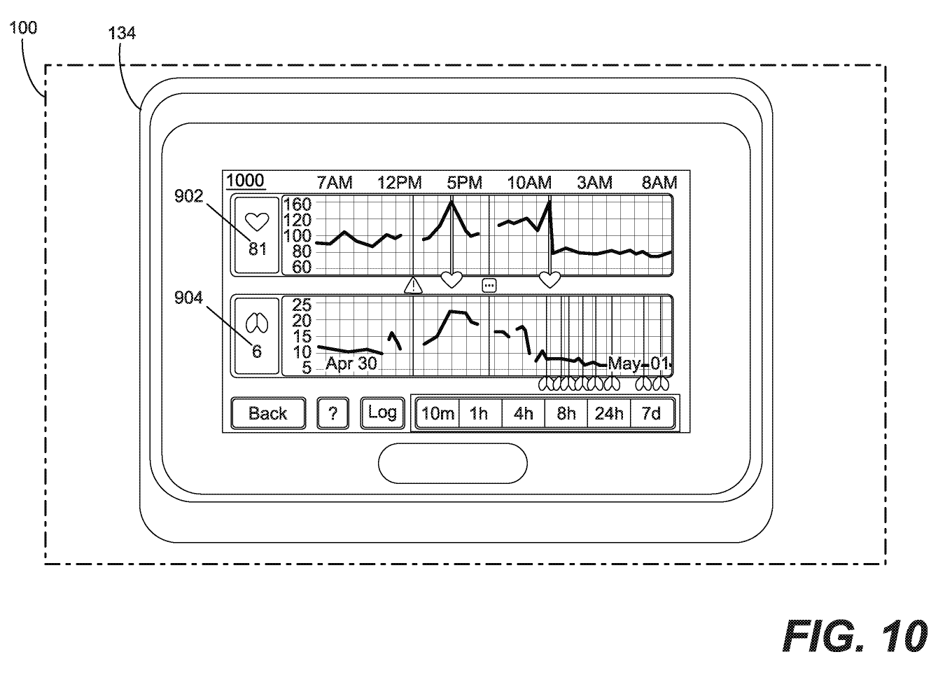

FIG. 10 illustrates an example of a graphical user interface 1000 that can be displayed on the display 134 of the patient support apparatus 100. The graphical user interface 1000 displays input parameters 900 captured by the monitoring device 730 such as the heart rate measurements 902 and the respiration rate measurements 904. In this example, the heart rate measurements 902 and the respiration rate measurements 904 are monitored over a period of 24 hours. The heart rate measurements 902 and the respiration rate measurements 904 are included in the input parameters 900 that are fed into the AI optimization tool 708 to determine an optimal state of at least one of the deck 106 and the patient support surface 104.

Referring back to FIG. 9, the input parameters 900 can include additional patient status inputs captured by the load cells 710 of the patient support apparatus 100 such as patient position 906, patient center of gravity or weight distribution 908, patient motion 910, and a quantity and/or frequency of exits 912 by the patient P from the patient support apparatus 100.

The input parameters 900 can further include data inputs from external systems. For example, the input parameters 900 can include data acquired from the EHR system 40 such as patient health history 914, patient demographic information 916, patient diagnoses and co-morbidities 918, patient medications 920, and patient surgeries and treatments 922. The input parameters 900 can also include data 924 acquired from the ADT system 50 and/or the nurse call system 60 such as a date and time of arrival of the patient P at the healthcare facility, transfers of the patient P between different units or departments within the healthcare facility or between other healthcare facilities, and a quantity and/or frequency of nurse calls by the patient P. Additional data inputs from external systems can include a geography designation of where the patient support apparatus 100 is located (e.g., region, country, city, and the like).

The input parameters 900 can further include statuses of the patient support apparatus 100 such as a deck status 926 including the relative positioning between the head section 170, the seat section 172, and the foot section 174 of the deck 106, and a height of the deck 106 relative to the floor. The input parameters 900 can also include a patient support surface status 928 such as the pressures inside the bladders of the patient support surface 104. The input parameters 900 can also include a therapy status 930 such as whether one or more of the P&V mode 742, the CLRT mode 744, and the MCM mode 746 are being executed on the patient support apparatus 100. Additional statuses of the patient support apparatus 100 can include statuses of one or more components of the patient support apparatus 100 such as statuses of the siderails and a status of the brake.

Referring back to FIG. 8, the method 800 includes an operation 804 of determining an optimal state of at least one of the deck 106 and the patient support surface 104. Operation 804 includes determining the optimal state of the at least one of the deck 106 and the patient support surface 104 by using artificial intelligence to analyze the input parameters 900 received in operation 802 including the measurements of the at least one physiological variable, the positioning of the articulable sections of the deck 106, and pressures inside bladders of the patient support surface 104.

The optimal state of the deck 106 can include relative angles between the head section 170, the seat section 172, and the foot section 174 that are adjustable by the second set of actuators 166 as shown in FIGS. 4-6. The optimal state of the deck 106 can further include a height of the deck 106 relative to the floor which is controlled by the first set of actuators 162.

The optimal state of the patient support surface 104 can include optimal pressures inside the various bladders of the patient support surface 104 such as the support bladders 180 including the head-support bladders 188, the seat-support bladders 190, and the foot-support bladders 192. The optimal state of the patient support surface 104 can further include one or more therapy modes 740 such as controlling the inflation and deflation of the percussion and vibration bladders 184 to execute the P&V mode 742 on the patient support apparatus 100, and controlling the inflation and deflation of the rotation bladders 182 to execute the CLRT mode 744 on the patient support apparatus 100.

The method 800 includes an operation 806 of generating a controllable function that causes the at least one of the deck 106 and the patient support surface 104 to have the optimal state. In some examples, the controllable function includes an input that is generated for display on a graphical user interface, and the input when selected causes the at least one of the deck 106 and the patient support surface 104 to have the optimal state. The input is an example of the “optimize” button that is generated by the AI optimization tool 708. The input can be displayed on a graphical user interface displayed on the display 134 mounted on the patient support apparatus 100. Alternatively, or additionally, the input can be displayed on a graphical user interface displayed on a device 62 communicatively coupled to the nurse call system 60.

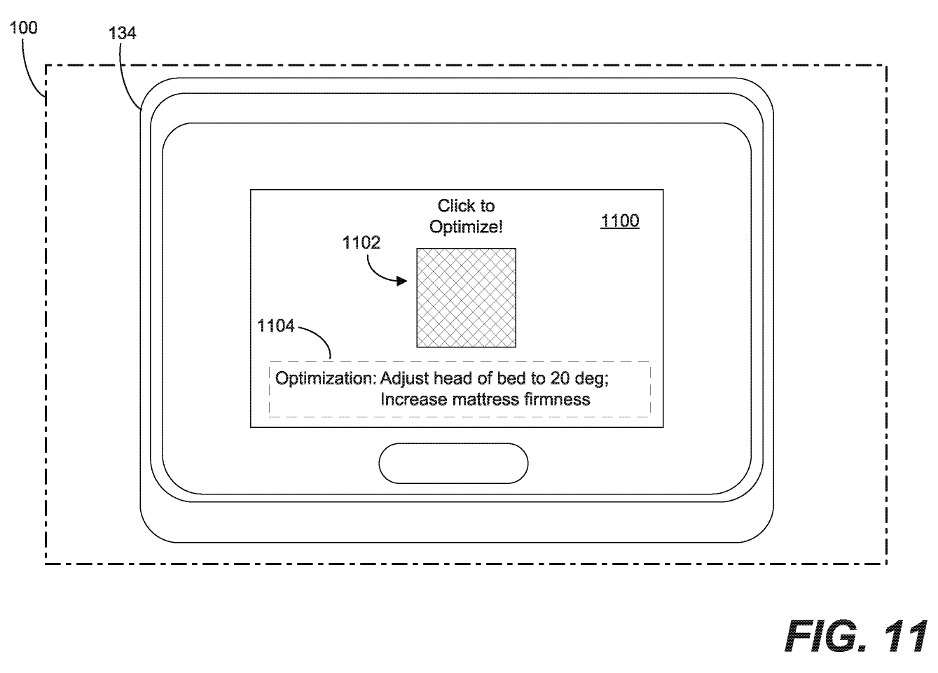

FIG. 11 illustrates another example of a graphical user interface 1100 displayed on the display 134 of the patient support apparatus 100 that includes an optimize button 1102 generated by the AI optimization tool 708 in accordance with the method 800. In this example, the display 134 includes a touchscreen. Selection of the optimize button 1102 on the touchscreen of the display 134 causes the patient support apparatus to adjust at least one of the patient support surface 104 and the deck 106 to provide an optimal configuration based on the input parameters 900 received in operation 802. For example, selection of the optimize button 1102 can cause the first set of actuators 162 to adjust a distance between the upper frame 164 and the lower frame 160 to adjust a height of the patient support surface 104 relative to the floor, and/or can cause the second set of actuators 166 to adjust relative angles between the head section 170, the seat section 172, and the foot section 174 of the deck 106 to adjust the contour and/or orientation of the patient support surface 104.

Alternatively, or additionally, selection of the optimize button 1102 can cause the pump 724 to adjust the pressures inside the various bladders of the patient support surface 104 such as one or more of the support bladders 180. Alternatively, or additionally, selection of the optimize button 1102 can cause a therapy to be performed on the patient support apparatus 100 such as the P&V mode 742 which causes rapid inflation and deflation of the percussion and vibration bladders 184, and/or the CLRT mode 744 which causes the rotation bladders 182 to inflate and deflate to position the patient P from side to side on a continuous or intermittent basis. Alternatively, or additionally, selection of the optimize button 1102 can cause the patient support apparatus 100 to perform the MCM mode 746 in instances when it has been turned off.

As further shown in FIG. 11, the graphical user interface 1100 further includes an explanation box 1104 that describes the adjustments to the operation of the patient support apparatus 100 that will occur upon selection of the optimize button 1102 (e.g., “Adjust head of bed to 20 degrees; Increase mattress firmness”). This allows a user to know the changes that will be implemented upon selection of the optimize button 1102 to inform their decision on whether to select the optimize button 1102, or to not select the optimize button 1102.

Advantageously, the AI optimization tool 708 can determine optimal relative angles of the head section 170, the seat section 172, and the foot section 174 of the deck 106 based on the input parameters 900 including physiological parameters measured in real-time such as heart rate and respiration rate. For example, the AI optimization tool 708 can determine an optimal inclination of the head section 170 of the deck 106 (e.g., 20 degrees versus 30 degrees) that is associated with improved patient outcomes based on physiological parameters measured in real-time. Further, the optimal state of the deck 106 can be further based on at least one of the position, the weight distribution, and the movements of the patient P. Recognition of such subtleties in combination with one another is not possible without artificial intelligence.

Further, the AI optimization tool 708 can determine optimal inflation pressures of the various bladders of the patient support surface 104 based on the input parameters 900 including physiological parameters measured in real-time such as heart rate and respiration rate. For example, the AI optimization tool 708 can determine optimal pressure distribution in the head-support bladders 188, the seat-support bladders 190, and the foot-support bladders 192 that are associated with improved patient outcomes based on physiological parameters measured in real-time. Further, the optimal state of the patient support surface 104 can be further based on at least one of the position, the weight distribution, and the movements of the patient P when resting on the patient support surface 104. Recognition of such subtleties in combination is not possible without artificial intelligence.

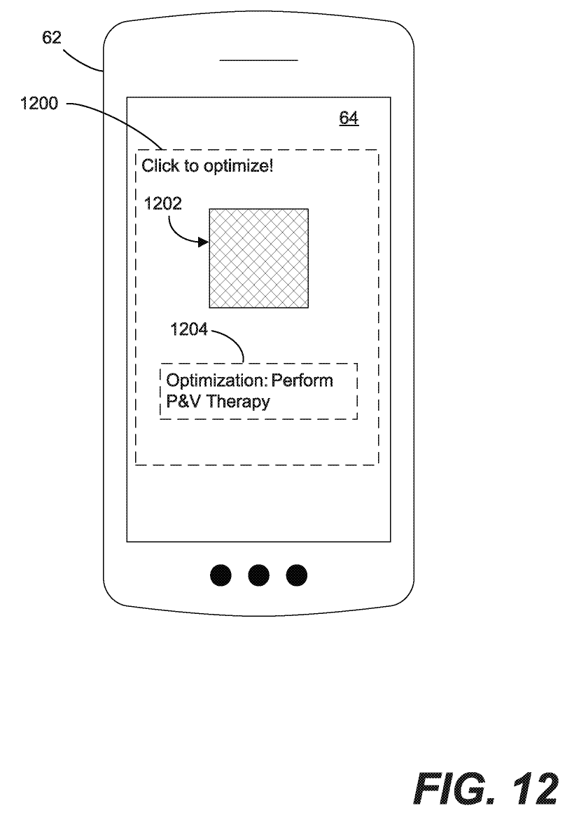

FIG. 12 illustrates an example of a graphical user interface 1200 displayed on a display 64 of a device 62 that is communicatively connected to the nurse call system 60. The graphical user interface 1200 includes an optimize button 1202 generated by the AI optimization tool 708. The graphical user interface 1200 further includes an explanation box 1204 that describes the adjustments to the operation of the patient support apparatus 100 that will occur upon selection of the optimize button 1202 (e.g., “Perform P&V Therapy”).

Advantageously, selection of the optimize button 1202 provides remote operation of the patient support apparatus 100 to optimize one or more settings of the patient support apparatus 100 when a caregiver is not present bedside. For example, selection of the optimize button 1202 can cause the pump 724 to adjust the pressures inside the various bladders of the patient support surface 104 such as one or more of the support bladders 180. Alternatively, or additionally, selection of the optimize button 1202 can cause a therapy to be performed on the patient support apparatus 100 such as the P&V mode 742 and/or the CLRT mode 744. Alternatively, or additionally, selection of the optimize button 1202 can cause the patient support apparatus 100 to perform the MCM mode 746 in instances when it has been turned off.

In some examples, the optimization provided by the optimize button 1202 when displayed on the device 62 is limited to optimizing the state of the patient support surface 104 because moving one or more components of the frame 102 is allowed only when a caregiver is present bedside for patient safety. For example, selection of the optimize button 1202 does not cause the first set of actuators 162 to adjust a height of the patient support surface 104 relative to the floor, and does not cause the second set of actuators 166 to adjust relative angles between the head section 170, the seat section 172, and the foot section 174 of the deck 106 when a caregiver is not present bedside. Instead, the first set of actuators 162 and the second set of actuators 166 are actuated only when a caregiver is present bedside. The presence of the caregiver proximate to the patient support apparatus 100 can be detected by the sensor 748 (see FIG. 7) detecting a wireless signal emitted by a tag attached to an object worn or otherwise carried by the caregiver.

The various embodiments described above are provided by way of illustration only and should not be construed to be limiting in any way. Various modifications can be made to the embodiments described above without departing from the true spirit and scope of the disclosure.

What is claimed is:

1. A patient support apparatus, comprising:
a frame;
a deck supported on the frame, the deck having articulable sections that are configured to support a patient support surface;
position sensors configured to detect a positioning of the articulable sections of the deck;
pressure sensors configured to detect pressures inside bladders of the patient support surface;
at least one actuator mounted on the frame, the at least one actuator configured to adjust a state of at least one of the deck and the patient support surface;
a monitoring device having one or more sensors that measure at least one physiological variable of a patient when resting on the patient support surface without contacting the patient; and
a controller communicatively coupled to the position sensors, the pressure sensors, the at least one actuator, and the monitoring device, the controller having at least one processing device, and at least one memory device storing software instructions that, when executed by the at least one processing device, cause the at least one processing device to:
receive measurements of the at least one physiological variable of the patient;
determine an optimal state of at least one of the deck and the patient support surface, the optimal state determined by artificial intelligence analyzing the measurements of the at least one physiological variable, the positioning of the articulable sections of the deck, and the pressures inside bladders of the patient support surface; and
generate a controllable function that causes the at least one of the deck and the patient support surface to have the optimal state.

2. The patient support apparatus of claim 1, further comprising:
one or more load cells configured to detect a position, a weight distribution, and motion of the patient when resting on the patient support surface; and
wherein the optimal state of the at least one of the deck and the patient support surface is further based on at least one of the position, the weight distribution, and the motion of the patient.

3. The patient support apparatus of claim 2, wherein the one or more load cells detect when the patient exits the patient support apparatus, and wherein the optimal state of the at least one of the deck and the patient support surface reduces a frequency of exits from the patient support apparatus.

4. The patient support apparatus of claim 1, wherein the at least one actuator includes a pump configured to inflate the bladders of the patient support surface, and wherein the optimal state includes optimal pressures inside the bladders of the patient support surface.

5. The patient support apparatus of claim 1, wherein the optimal state includes controlling the pump to inflate and deflate the bladders of the patient support surface to perform a percussion and vibration therapy or a continuous lateral rotation therapy.

6. The patient support apparatus of claim 1, wherein the at least one actuator includes one or more electric motors configured to move the articulable sections of the deck relative to one another, and wherein the optimal state includes a positioning of the articulable sections.

7. The patient support apparatus of claim 1, further comprising:
a touchscreen display mounted on the patient support apparatus; and
wherein the controllable function includes an input displayed on a user interface that is generated on the touchscreen display, and the input when selected causes the at least one of the deck and the patient support surface to have the optimal state.

8. The patient support apparatus of claim 1, wherein the at least one physiological variable includes at least one of a heart rate and a respiration rate.

9. A method of operating a patient support apparatus, the method comprising:
receiving measurements of at least one physiological variable of a patient resting on a patient support surface without contacting the patient;
determining an optimal state of at least one of the patient support surface and articulable sections of a deck that supports the patient support surface, the optimal state determined by artificial intelligence analyzing the measurements of the at least one physiological variable, a positioning of the articulable sections of the deck, and pressures inside bladders of the patient support surface; and
generating a controllable function that causes the at least one of the deck and the patient support surface to have the optimal state.

10. The method of claim 9, further comprising:
determining the optimal state of the at least one of the patient support surface and the articulable sections of the deck by having the artificial intelligence analyze at least one of a position of the patient, a weight distribution of the patient, and motion by the patient.

11. The method of claim 9, wherein the optimal state includes a relative positioning between the articulable sections of the deck.

12. The method of claim 9, wherein the optimal state includes optimal pressures inside the bladders of the patient support surface.

13. The method of claim 9, wherein the optimal state includes controlling the bladders of the patient support surface to perform a percussion and vibration therapy or a continuous lateral rotation therapy.

14. The method of claim 9, wherein the controllable function includes an input displayed on a user interface generated on a touchscreen display mounted on the patient support apparatus, and the input when selected causes the at least one of the deck and the patient support surface to have the optimal state.

15. The method of claim 9, wherein the at least one physiological variable includes at least one of a heart rate and a respiration rate.

16. A controller for a patient support apparatus, the controller comprising:
at least one processing device; and
at least one memory device storing software instructions that, when executed by the at least one processing device, cause the at least one processing device to:
receive measurements of at least one physiological variable of a patient resting on a patient support surface without contacting the patient;
determine an optimal state of at least one of the patient support surface and articulable sections of a deck that supports the patient support surface, the optimal state determined by artificial intelligence analyzing the measurements of the at least one physiological variable, a positioning of the articulable sections of the deck, and pressures inside bladders of the patient support surface; and
generate a controllable function that causes the at least one of the deck and the patient support surface to have the optimal state.

17. The controller of claim 16, wherein the at least one memory device stores additional software instructions that, when executed by the at least one processing device, further cause the at least one processing device to:
determine the optimal state of the at least one of the patient support surface and the articulable sections of the deck by having the artificial intelligence analyze at least one of a position of the patient, a weight distribution of the patient, and motion by the patient.

18. The controller of claim 16, wherein the optimal state includes at least one of a relative positioning between the articulable sections of the deck and optimal pressures inside the bladders of the patient support surface.

19. The controller of claim 16, wherein the optimal state includes controlling the bladders of the patient support surface to perform a percussion and vibration therapy or a continuous lateral rotation therapy.

20. The controller of claim 16, wherein the controllable function includes an input displayed on a user interface generated on a touchscreen display mounted on the patient support apparatus, and the input when selected causes the at least one of the deck and the patient support surface to have the optimal state.
